(19) United States
(12) Patent Application Publication
(10) Pub. No.: US 2011/0096099 A1
(43) Pub. Date: Apr. 28, 2011

(54) BACKLIGHT DRIVE DEVICE, DISPLAY DEVICE EQUIPPED WITH SAME, AND BACKLIGHT DRIVE METHOD

(75) Inventors: Manabu Yamamoto, Osaka (JP); Ken Nakazawa, Osaka (JP); Akira Tomiyoshi, Osaka (JP)

(73) Assignee: Sharp Kabushiki Kaisha, Osaka--shi, Osaka (JP)

(21) Appl. No.: 12/737,161

(22) PCT Filed: Jun. 24, 2009
(86) PCT No.: PCT/JP2009/061485

§ 371 Date: Dec. 14, 2010

(30) Foreign Application Priority Data
Jul. 11, 2008 (JP) 2008-181017

(51) Int. Cl. G09G 5/10

(52) U.S. Cl. 345/690

(57) ABSTRACT

A backlight drive device is provided in at least one embodiment including a plurality of backlight units for each of which a unique address is automatically set using a simplified configuration, in which backlight drive units are sequentially connected to a backlight drive control portion via a serial signal line by a daisy-chain method, and through this, the backlight drive control portion transmits an address-assigning signal sequentially to each of the units before sending luminance data. Also, in at least one embodiment, the backlight drive control portion is directly connected to the backlight drive units via an IIC bus by a bus method, and through this, the backlight drive control portion receives light-quantities and temperatures detected by the units identified by the addresses as mentioned above. This configuration allows automatic setting of unique addresses, which makes it possible to use common backlight drive units.

### TECHNICAL FIELD

The present invention relates to, for example, backlight drive devices for driving backlights to illuminate liquid crystal panels from behind and display devices equipped with the same, and the invention particularly relates to a backlight drive device having a function (backlight dimming function) for controlling the luminance of a plurality of backlights and a display device equipped with the same.

### BACKGROUND ART

In recent years, backlight-equipped display devices, such as liquid crystal display devices, have been becoming larger, and such large-sized display devices are often equipped with a plurality of backlights to illuminate a wider display area.

Backlights equipped in such a display device are required to uniformly illuminate a display area and they need to be controlled for that purpose. Accordingly, such a display device is equipped with a drive control portion for controlling the luminance of backlights independently of each other and is also equipped with signal lines for transmitting control signals.

For example, Japanese Laid-Open Patent Publication No. 2007-165336 discloses a configuration of a backlight drive device in which a plurality of backlight units and a drive control portion are daisy-chain coupled. In this conventional configuration, each backlight unit is provided with a light-quantity detecting means, and data for the quantity of light detected at each backlight unit by the light-quantity detecting means is transmitted piece by piece to the drive control portion.

### CITATION LIST

### Patent Literature

[Patent Document 1] Japanese Laid-Open Patent Publication No. 2007-165336

### DISCLOSURE OF THE INVENTION

### Problems to be Solved by the Invention

Here, in the conventional backlight drive device, to identify which backlight unit has transmitted light-quantity data to the drive control portion, a predetermined unique address is set for each backlight unit. Accordingly, in case any one of the backlight units fails, repair would be difficult and expensive.

Also, by providing a DIP switch or suchlike so that the address can be manually set at the discretion, it becomes possible to use common backlight units. However, an address-setting operation is required upon replacement, so that repair would be time-consuming and setting errors would readily occur.

Therefore, objectives of the present invention are to provide a backlight drive device including a plurality of backlight units for each of which a unique address is automatically set using a simplified configuration and also to provide a display device equipped with the same.

### Solution to the Problems

A first aspect of the present invention is directed to a backlight drive device for controlling the luminance of a backlight including a plurality of light sources, the device comprising:

a plurality of drive units for controlling the luminance of one or more of the light sources, each drive unit including a detector for detecting one or more physical quantities including a light quantity and an ambient temperature of the one or more light sources, the one or more physical quantities being related to the luminance of the one or more light sources;

a control portion for receiving the physical quantity detected by the detector and generating and outputting a luminance data signal for controlling the luminance of a corresponding light source, based on the received physical quantity;

a first signal line for transmitting the luminance data signal and sequentially connecting the control portion to the drive units by a daisy-chain method; and

a second signal line for transmitting a signal indicating the physical quantity and connecting the drive units to the control portion by a bus method, wherein,

the control portion sequentially assigns unique addresses to the drive units via the first signal line, thereby allowing reception of the signal indicating the physical quantity from any of the drive units via the second signal line.

In a second aspect of the present invention, based on the first aspect of the invention, each of the drive units includes a plurality of detectors for detecting different physical quantities, the detectors add their respective different values to the address assigned to the drive unit including the detectors, thereby generating different addresses, and the control portion receives the signal indicating the physical quantity from any of the detectors via the second signal line.

In a third aspect of the present invention, based on the second aspect of the invention, each of the detectors includes an A/D converter for converting the detected physical quantity into digital data, and the A/D converter has a previously fixed and set value to be added to the address, the value being common among the same type of A/D converters included in other drive units but being different from those of other A/D converters included in the same drive unit.

In a fourth aspect of the present invention, based on the third aspect of the invention, each of the drive units includes a driver for controlling the luminance of the one or more light sources based on the luminance data signal provided via the first signal line, and the driver receives the address provided via the first signal line and provides the address to the A/D converter.

In a fifth aspect of the present invention, based on the third aspect of the invention, the detectors include first and second detectors for respectively detecting the light quantity of the one or more light sources and the ambient temperature, and the A/D converters included in the first and second detectors have their respective input terminals capable of setting part or all of the addresses to be generated, one input terminal having either a ground potential or a power-supply potential consistently applied thereto so as to be at a different potential from the other input terminal.

In a sixth aspect of the present invention, based on the first aspect of the invention, the control portion communicates with the drive units via the second signal line by an IIC bus method.

A seventh aspect of the present invention is directed to a backlight drive method for controlling the luminance of a backlight including a plurality of light sources, the method comprising:

a drive step by a plurality of drive units for controlling the luminance of one or more of the light sources, each drive unit including a detector for detecting one or more physical quantities including a light quantity and an ambient temperature of the one or more light sources, the one or more physical quantities being related to the luminance of the one or more light sources;

a control step by a control portion for receiving the physical quantity detected by the detector and generating and outputting a luminance data signal for controlling the luminance of a corresponding light source, based on the received physical quantity;

a first transmission step of transmitting the luminance data signal via a first signal line sequentially connecting the control portion to the drive units by a daisy-chain method; and

a second transmission step of transmitting a signal indicating the physical quantity via a second signal line connecting the drive units to the control portion by a bus method, wherein,

in the control step, unique addresses are sequentially assigned to the drive units via the first signal line, thereby allowing reception of the signal indicating the physical quantity from any of the drive units via the second signal line.

### EFFECT OF THE INVENTION

According to the first aspect of the present invention, the control portion sequentially assigns unique addresses to the drive units via the first signal line, allowing reception of a signal indicating physical quantities, such as a temperature and a quantity of light, from any of the drive unit via the second signal line, and therefore it is possible to carry out communications via a bus without presetting fixed addresses, thereby making it possible to employ common backlight drive units.

According to the second aspect of the present invention, the detectors add their respective different values to the address assigned to the drive unit, thereby generating different addresses, which makes it possible to achieve size reduction and simplified composition of data for the address to be assigned to the drive unit. Also, corresponding addresses can be readily set for all detectors by simply assigning one address to the drive unit.

According to the third aspect of the present invention, each A/D converter has a previously fixed and set value to be added to the address, the value being common among the same type of A/D converters included in other drive units but being different from those of other A/D converters included in the same drive unit, and therefore addresses of all A/D converters can be readily set by simply providing one address to one drive unit.

According to the fourth aspect of the present invention, the driver for controlling the luminance of the light source provides the address to the A/D converter, and therefore addresses of all A/D converters can be readily set by simply providing addresses to the drive units in the same manner as providing the luminance data.

According to the fifth aspect of the present invention, it is possible to set the address of each A/D converter included in the first and second detectors using a simplified configuration.

According to the sixth aspect of the present invention, the IIC bus, which is a widely used bus connection method, is employed, thereby making it possible to achieve a simplified device configuration and reduce production cost.

According to the seventh aspect of the present invention, the backlight drive method can achieve the same effect as that achieved by the first aspect of the present invention.

### BRIEF DESCRIPTION OF THE DRAWINGS

FIG. 1 is a block diagram illustrating the configuration of a liquid crystal display device according to an embodiment of the present invention.

FIG. 2 is a diagram illustrating the details of a backlight provided in the liquid crystal display device according to the embodiment.

FIG. 3 is a block diagram illustrating the configuration of the backlight provided in the liquid crystal display device according to the embodiment.

FIG. 4 is a block diagram illustrating detailed configurations of backlight drive units in the embodiment.

FIG. 5 is a block diagram illustrating a detailed configuration of a unit driver in the embodiment.

FIG. 6 is a chart illustrating waveforms of a data signal, a clock signal and a test latch signal for initial operation in the embodiment.

FIG. 7 is a chart illustrating waveforms of the data signal, the clock signal and the data latch signal for normal operation in the embodiment.

FIG. 8 is a chart illustrating waveforms of an LED clock signal and switch control signals in the embodiment.

### MODE FOR CARRYING OUT THE INVENTION

Hereinafter, an embodiment of the present invention will be described with reference to the accompanying drawings.

<1. Overall Configuration and Operation Summary>

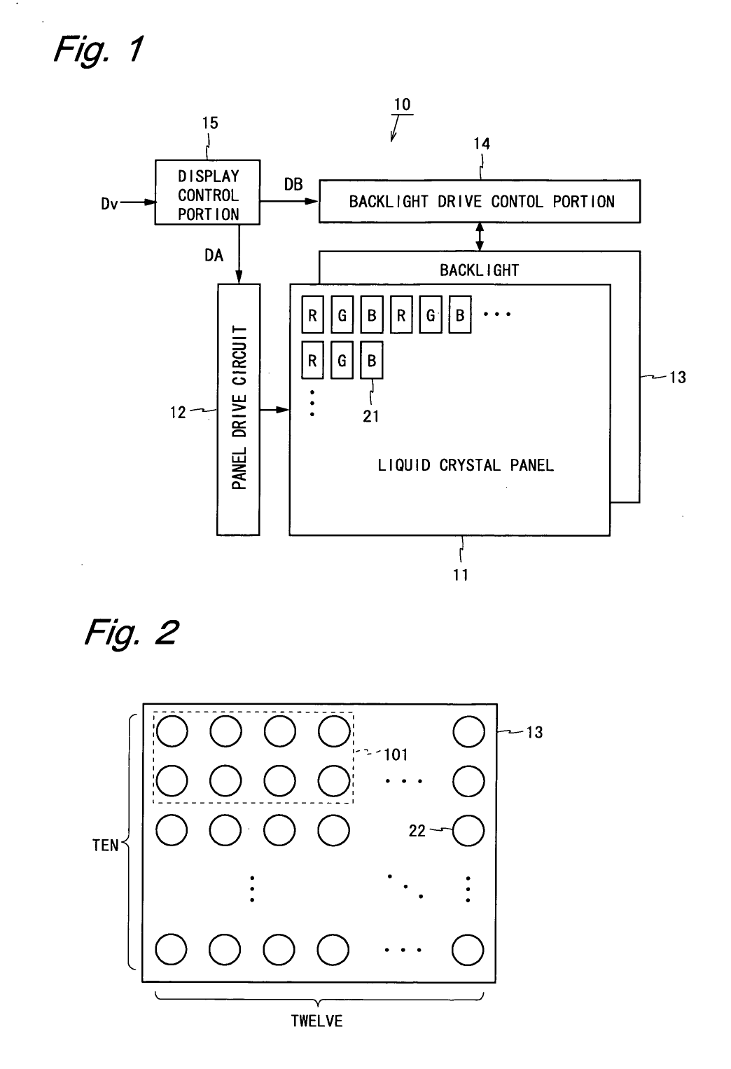

FIG. 1 is a block diagram illustrating the configuration of a liquid crystal display device 10 according to an embodiment of the present invention. The liquid crystal display device 10 shown in FIG. 1 includes a liquid crystal panel 11, a panel drive circuit 12, a backlight 13, a backlight drive portion 14, and a display control portion 15. The liquid crystal display device 10 drives the liquid crystal panel 11 and controls the luminance of a plurality of light sources included in the backlight 13.

The liquid crystal panel 11 includes (m×n×3) display elements 21. The display elements 21 are arranged two-dimensionally as a whole, with 3m elements provided in the row direction (in FIG. 1, the horizontal direction) and n elements provided in the column direction (in FIG. 1, the vertical direction). The display elements 21 include “R”, “G” and “B” display elements, which transmit red, green and blue components, respectively, of white light therethrough. The “R”, “G” and “B” display elements are arranged side by side in the row direction with each group of the three forming a single pixel.

The panel drive circuit 12 is a circuit for driving the liquid crystal panel 11. The panel drive circuit 12 outputs a signal (a voltage signal) for controlling the light transmittance of the display elements 21 to the liquid crystal panel 11, based on liquid crystal data DA outputted by the display control portion 15. The voltage outputted by the panel drive circuit 12 is written to pixel electrodes (not shown) in the display elements 21, and the light transmittance of the display elements 21 changes in accordance with the voltage written to the pixel electrodes.

The backlight 13 is provided at the backside of the liquid crystal panel 11 to irradiate the back of the liquid crystal panel 11 with backlight. FIG. 2 is a diagram illustrating the details of the backlight 13. The backlight 13 includes (10×12) white LEDs 22, as shown in FIG. 2. The white LEDs 22 are arranged two-dimensionally as a whole, with 12 LEDs provided in the row direction and 10 LEDs provided in the column direction. Each group of eight white LEDs 22 is driven by one backlight drive unit. In FIG. 2, a total of eight white LEDs 22 in the top left corner, four in the row direction and two in the column direction, are driven by a backlight drive unit 101 indicated by dotted lines. Also, each backlight drive unit includes a light-quantity detector for detecting the quantity of light from the white LEDs 22 and a temperature detector for detecting an ambient temperature. The backlight drive units will be described in detail later. Light emitted by the white LEDs 22 is incident on a portion of the back of the liquid crystal panel 11.

The backlight drive portion 14 is a circuit for controlling drive of the backlight 13. The backlight drive portion 14 outputs signals for controlling the luminance of all white LEDs 22 to the backlight drive units in the backlight 13, based on LED data DB outputted by the display control portion 15 and also based on the quantities of light and ambient temperatures of the white LEDs 22 as will be described later. The luminance of each LED 22 is controlled independently of the luminance of other LEDs 22 inside and outside the same unit.

The display control portion 15 outputs the LED data DB, which indicates the luminance of all white LEDs 22 included in the backlight 13, to the backlight drive portion 14 based on a display mode being set and image data Dv. Also, the display control portion 15 obtains the light transmittance of all display elements 21 included in the liquid crystal panel 11 based on the image data Dv, and outputs liquid crystal data DA, which indicates the obtained light transmittance, to the panel drive circuit 12.

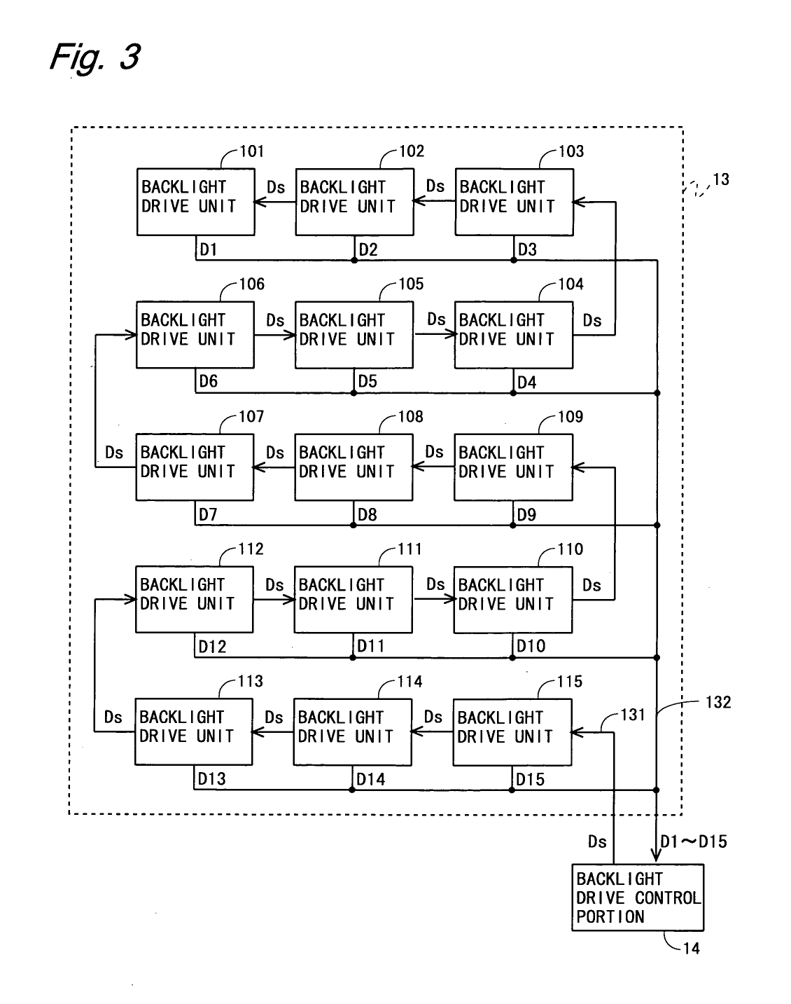

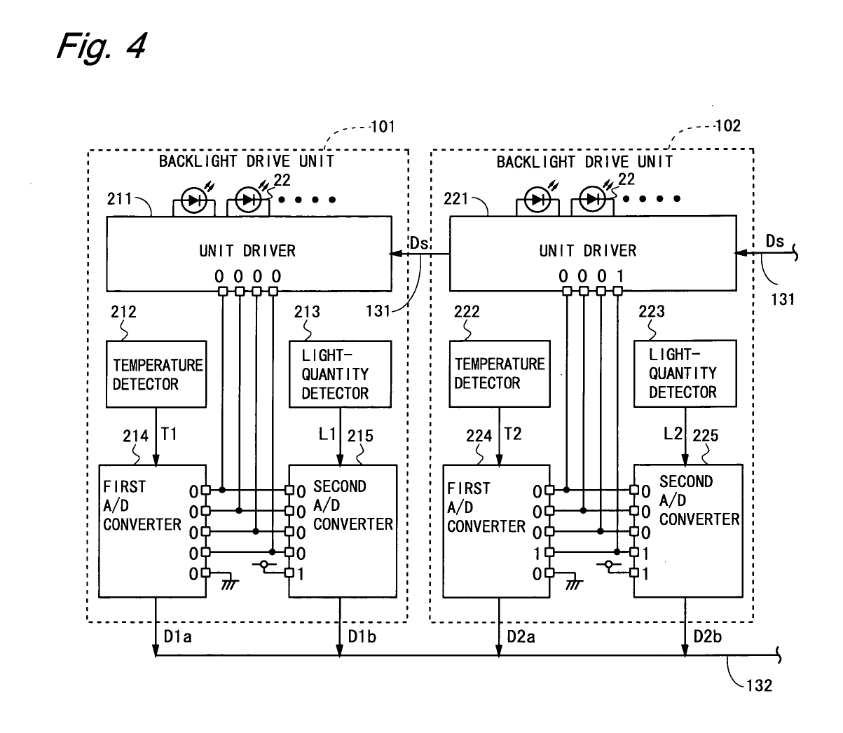

According to the liquid crystal display device 10 thus configured, proper liquid crystal data DA and proper LED data DB are obtained based on image data Dv, and the light transmittance of the display elements 21 is controlled based on the liquid crystal data DA, so that the image data Dv can be displayed on the liquid crystal panel 11. Next, referring to FIGS. 3 and 4, the backlight and the backlight drive units included therein will be described with respect to their configurations and operations.

<2. Configurations and Operations of the Backlight And the Backlight Drive Units>

FIG. 3 is a block diagram illustrating the configuration of the backlight 13 in the present embodiment. The backlight 13 includes 15 backlight drive units 101 to 115 for controlling 120 white LEDs 22, as described above. The backlight drive units 101 to 115 are configured in the same manner except for connections with signal lines. Their detailed configurations will be described later with reference to FIG. 4.

As shown in FIG. 3, the backlight drive units 101 to 115 are connected to the backlight drive control portion 14 via a serial signal line 131, which transmits serial data to be described later, and an IIC (Inter-Integrated Circuit) bus 132, which is a bus standard proposed by Philips. Note that the IIC bus is also noted as “I²C bus”.

The serial signal line 131 connects the backlight drive control portion 14 sequentially to the backlight drive units 101 to 115 one by one. Specifically, the serial signal line 131 provides a sequential connection up to the backlight drive unit 101 by a so-called daisy chain method, such that the backlight drive control portion 14 is connected to the backlight drive unit 115, which is in turn connected to the next backlight drive unit 114 to be connected to the next backlight drive unit 113. As will be described later, upon an initial operation, the backlight drive control portion 14 sequentially transmits address-assigning signals to the backlight drive units 101 to 115, and thereafter, during a normal operation, the backlight drive control portion 14 sequentially transmits luminance data signals Ds to the backlight drive units 101 to 115 in order to control the luminance of the white LEDs 22 included in the backlight drive units.

The IIC bus 132 directly connects the backlight drive control portion 14 to the backlight drive units 101 to 115 by a so-called bus method. As will be described later, when a communication state is established, the backlight drive units 101 to 115 transmit anyone data piece from among digital data D₁ to D₁₅, which correspond to quantities of light and temperatures detected by the light-quantity detectors and the temperature detectors included in the units, to the backlight drive control portion 14 via the IIC bus 132.

FIG. 4 is a diagram illustrating detailed configurations of the backlight drive units 101 and 102. As shown in FIG. 4, the backlight drive unit 101 includes eight white LEDs 22, a unit driver 211 for driving them, a temperature detector 212 for detecting temperatures of the white LEDs 22 included in the backlight drive unit 101, a first A/D converter 214 for converting analog data T₁, which indicates detected temperatures, into digital data, a light-quantity detector 213 for detecting quantities of light from the white LEDs 22, and a second A/D converter 215 for converting analog data L₁, which indicates detected quantities of light, into digital data.

Also, the backlight drive unit 102 have the same components as those of the backlight drive unit 101, i.e., eight white LEDs 22, a unit driver 221, a temperature detector 222, a first A/D converter 224 for converting analog data T₂, which indicates temperatures, into digital data, a light-quantity detector 223, and a second A/D converter 225 for converting analog data L₂, which indicates detected quantities of light, into digital data. However, their addresses are different, which will be described later. In addition, all other backlight drive units 103 to 115 have the same components, and therefore only the configuration of the backlight drive unit 101 will be described in detail below.

The unit driver 211 outputs an address (here, 4 bits) through four address ports with one bit for each port, the address originally being included in a luminance data signal Ds transmitted from the backlight drive control portion 14, and the unit driver 211 causes the white LEDs 22 to light up with appropriate luminance based on the luminance data signal Ds transmitted by the backlight drive control portion 14. Note that the composition and other properties of the luminance data signal Ds will be described later.

The address ports included in the unit driver 211 are represented by squares in FIG. 4, and “0” or “1” noted within their vicinities indicates their bit values. Accordingly, the unique address of the unit driver 211 is “0000”, and as for the adjacent backlight drive unit 102, the address of the unit driver 221 included therein is “0001”.

Each address port of the unit driver 211 is connected to address input terminals provided to the first and second A/D converters 214 and 215. As shown in FIG. 4, each of the first and second A/D converters 214 and 215 is provided with five address input terminals as represented by squares, and four of them are connected to the address ports of the unit driver 211. The remaining one address input terminal provided to the first A/D converter 214 is connected to a ground potential, and the remaining one address input terminal provided to the second A/D converter 215 is connected to a power-supply potential. In this manner, by setting addresses to be partially fixed such that A/D converters within the same backlight drive unit can be distinguished from each other, it becomes possible to eliminate the need to set addresses of all A/D converters based on data from the serial signal line 131, thereby achieving size reduction and simplified composition of the data. Also, addresses of all A/D converters can be readily set by simply providing one address to one backlight drive unit.

The first and second A/D converters 214 and 215 add predetermined device identification bits “01” to high-order ends of bit strings designated by the address input terminals, thereby generating unique 7-bit addresses for communication via the IIC bus 132. Specifically, address values for the first and second A/D converters 214 and 215 are respectively “0100000” and “0100001”. Here, the procedure for communicating with the backlight drive control portion 14 via the IIC bus 132 will be described by taking the first A/D converter 214 as an example.

The IIC bus 132 includes two lines, a serial clock line and a serial data line, and communications are carried out by synchronizing with serial clocks SCL transmitted through the serial clock line while transmitting serial data SDA through the serial data line. Concretely, the backlight drive control portion 14 issues a start condition after release of the IIC bus 132, and transmits bit data including a 7-bit slave address (e.g., “0100000”) that corresponds to an A/D converter whose data is sought (e.g., the first A/D converter 214) and the least significant bit which indicates the direction of transmission/reception. The A/D converter having the slave address transmits digital data (here, digital data D₁ₐ corresponding to analog data T₁ which indicates a temperature) as serial data SDA, which is received by the backlight drive control portion 14. Thereafter, when the bus is released upon completion of the communications, the backlight drive control portion 14 issues a stop condition. Such communications are carried out with A/D converters (to receive, for example, digital data D_{1b} from the second A/D converter 215, digital data D₂a from the first A/D converter 224, and digital data D_{2b} from the second A/D converter 225), so that the backlight drive control portion 14 acquires light-quantity and ambient temperature data for all backlight drive units 101 to 115.

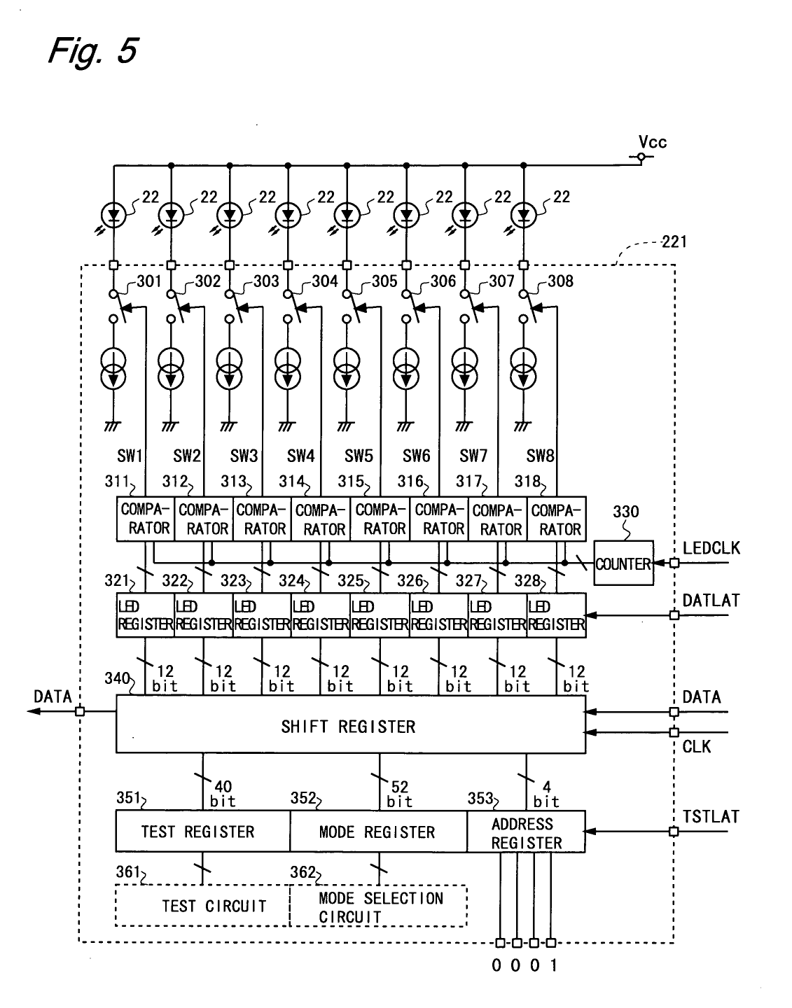

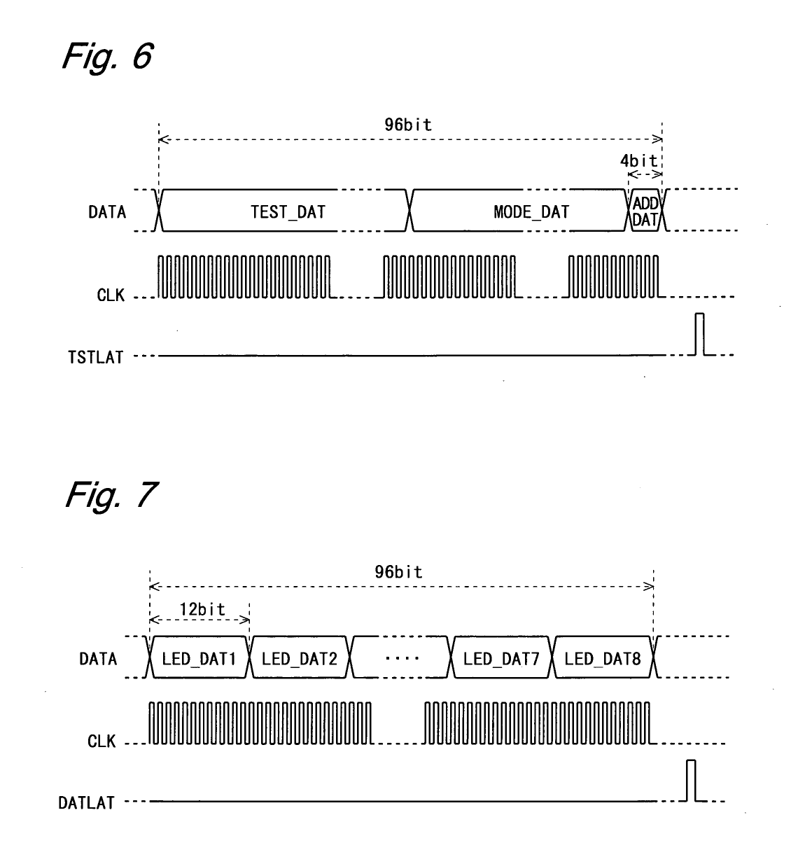

As described above, as for the unique 7-bit slave addresses of the A/D converters, four of five bits, excluding two high-order bits which are common among all the A/D converters, are transmitted to the backlight drive units via the serial signal line 131, and to set the remaining one of the five bits, corresponding address input terminals of the first and second A/D converters are connected to the ground potential and the power-supply potential, respectively. With such arrangements, it is possible to allow the backlight drive units 101 to 115 to have common configurations and their respective unique addresses (here, 4 bits), thereby making it possible to set unique slave addresses (here, 7 bits) for all the A/D converters. Accordingly, even if any of the backlight drive units 101 to 115 fails, it is only required to replace it with a new backlight drive unit having the same components (without making any special settings), and therefore it is possible to reduce the trouble and cost of repair. Next, referring to FIGS. 5 and 6, a detailed configuration and operation of the unit driver 221 will be described.

<3. Detailed Configuration and Operation of the Unit Driver>

FIG. 5 is a block diagram illustrating a detailed configuration of the unit driver 221. The unit driver 221 is included in the backlight drive unit 102 in order to drive each of eight corresponding white LEDs 22 with its appropriate luminance, and includes switches 301 to 308, comparators 311 to 318, LED registers 321 to 328, a counter 330, a shift register 340, a test register 351, a mode register 352, an address register 353, a test circuit 361, and a mode selection circuit 362. Their operations will be described in detail with reference to waveform charts in FIGS. 6 to 8.

FIG. 6 is a chart illustrating waveforms of a data signal DATA, a clock signal CLK and a test latch signal TSTLAT for initial operation. The data signal DATA, the clock signal CLK and the test latch signal TSTLAT, shown in FIG. 6, are signals included in a luminance data signal Ds provided to the backlight drive units 101 to 115 by the backlight drive control portion 14 via the serial signal line 131.

The data signal DATA is made of a total of 1440 bits, 96 bits for each of the backlight drive units 101 to 115, and the test latch signal TSTLAT is provided to each of the backlight drive units 101 to 115 for initial operation after the data is written to the shift register included in the unit driver of a corresponding backlight drive unit.

Specifically, the shift register 340 shown in FIG. 5 receives and writes therein a data signal DATA bit by bit from the right in the drawing, the data signal DATA being sent from an unillustrated shift register included in the unit driver of the backlight drive unit 103 via the serial signal line 131, and the value is shifted to the left in the figure in accordance with the clock signal CLK. The shift register 340 is a 96-bit shift register, and a data signal DATA made of a bit string shifted out to the left is provided to an unillustrated shift register included in the unit driver of the next backlight drive unit 101 via the serial signal line 131.

In this manner, the shift registers included in the backlight drive units 102 to 115 receive a bit string of the data signal DATA from the right in the drawing and shift it to the left for feeding to the next shift register, and therefore the shift registers included in the backlight drive units 101 to 115 collectively function as a virtual 1440-bit shift register. Accordingly, by latching a value that is written via a test latch signal TSTLAT provided for initial operation after 96-bit data is written to each of the shift registers, it becomes possible to provide the backlight drive units 101 to 115 with corresponding data in accordance with the order of their connections without identifying them by their unique addresses or suchlike.

Here, the data signal DATA for initial operation includes 96-bit data to be provided to the backlight drive units, which is made up of 40-bit test data TEST_DAT, 52-bit mode data MODE_DAT and 4-bit address data ADDDAT, as shown in FIG. 6. Note that the data signal DATA for initial operation is sent at specific times such as at the beginning of device activation or at the time of mode change.

Upon reception of the test latch signal TSTLAT as described above, the shift register 340 latches the written data signal DATA and provides 40-bit data (i.e., the test data TEST_DAT) to the test register 351 in the high-order (left end) to low-order direction (rightward), subsequent 52-bit data (i.e., the mode data MODE_DAT) to the mode register 352, and subsequent 4-bit data (i.e., the address data ADDDAT) to the address register 353.

The test register 351 holds the test data TEST_DAT received from the shift register 340 and provides it to the test circuit 361. The test circuit 361 performs light-up tests on the white LEDs 22 and operation tests on various circuits based on the provided test data TEST_DAT. Note that any detailed configuration and operation thereof are omitted.

The mode register 352 holds the mode data MODE_DAT received from the shift register 340 and provides it to the mode selection circuit 362. The mode selection circuit 362 selects any of various light-up modes, such as stand-by mode, in accordance with the provided mode data MODE_DAT, so that, for example, the amount of current flowing in the white LEDs 22 is adjusted. Note that any detailed configuration and operation thereof are omitted.

The address register 353 holds the address data ADDDAT received from the shift register 340, and sets the potential for each of the address ports corresponding to the four bits. Since the content of the address data ADDDAT here is “0001” as shown in FIGS. 4 and 5, the potential of the rightmost of the four address ports in the figures is set at logic level “High” (here, the power-supply potential) which corresponds to “1”, and the potential of the others is set at logic level “Low” (here, the ground potential) which corresponds to “0”. As described earlier with reference to FIG. 4, the address ports are connected to address input terminals included in the first and second A/D converters 224 and 225 to provide addresses for identifying the A/D converters. With such a simplified configuration, it is possible to sequentially provide unique addresses to the backlight drive units 102 to 115 via the serial signal line 131.

The data signal DATA for initial operation as described above is typically sent only once at the time of device activation, and subsequently, a data signal DATA for normal operation is repeatedly sent as shown in FIG. 7 below.

FIG. 7 is a chart illustrating waveforms of the data signal DATA, the clock signal CLK and the data latch signal DATLAT for normal operation: The data signal DATA, the clock signal CLK and the data latch signal DATLAT, shown in. FIG. 7, are signals included in a luminance data signal Ds provided to the backlight drive units 101 to 115 by the backlight drive control portion 14 via the serial signal line 131. Consequently, as in the case of initial operation, the shift registers included in the backlight drive units 101 to 115 collectively function as a virtual 1440-bit shift register, and after 96-bit data is written to each of the shift registers, it is latched with the data latch signal DATLAT provided for normal operation, so that corresponding data can be provided in accordance with the order of connections of the backlight drive units 101 to 115.

Here, as the 96-bit data to be provided to the backlight drive units, the data signal DATA for normal operation, unlike that for initial operation, includes eight pieces of 12-bit LED data LED_DAT₁ to LED_DAT_{E} as shown in FIG. 7.

Upon reception of the data latch signal DATLAT as described above, the shift register 340 latches the written data signal DATA and provides 12-bit data (i.e., the LED data LED_DAT₁) to the LED register 321 in the high-order (left end) to low-order direction (rightward), subsequent 12-bit data (i.e., the LED data LED_DAT₁) to the LED register 321, and corresponding data as far as to the last LED register 328.

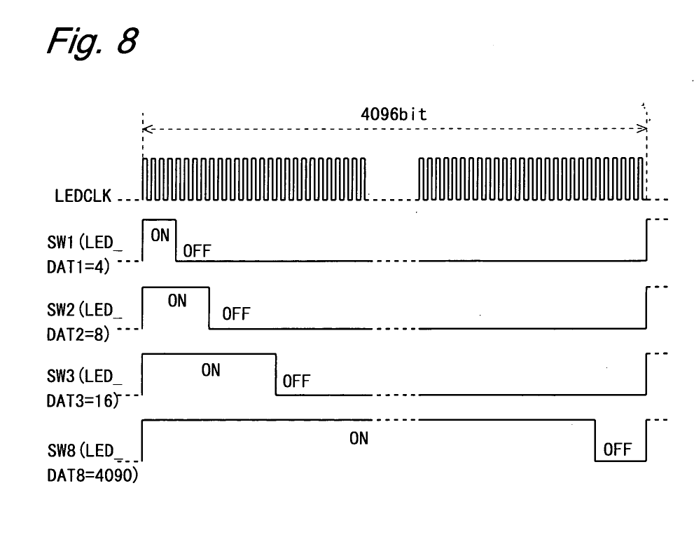

Upon reception of the data, the LED registers 321 to 328 hold and provide the data to their corresponding comparators 311 to 318. The comparators 311 to 318 compares register values, which are indicated by the data received from their corresponding LED registers 321 to 328, with a counter value provided by the counter 330, and keep the corresponding switches 301 to 308 on until the counter value exceeds the register value. Hereinafter, this operation will be described in detail with reference to FIG. 8.

FIG. 8 is a chart illustrating waveforms of an LED clock signal LEDCLK and switch control signals SW₁ to SW₄ and SW₈. The switch control signals SW₁ to SW₈ are control signals for on/off control provided to the switches 301 to 308 by the comparators 311 to 318, as shown in FIG. 5. Also, in FIG. 8, “LED_DAT₁=4” parenthesized after the switch control signal SW₁ indicates that the content of the LED data LED_DAT₁ is “4” and also means that the register value of the LED register 321 is “4”. Parenthesized expressions for the other switch control signals have similar meanings.

Here, the switches 301 to 308 shown in FIG. 5 are intended to connect/disconnect an internal constant current source to/from the white LEDs 22, and their on/off is controlled by the switch control signals SW₁ to SW₈ provided by their corresponding comparators 311 to 318.

The comparators 311 to 318 compare register values provided by the LED registers 321 to 328, which correspond to “ON” periods, with a count value provided by the counter 330, which is incremented one by one, and the corresponding switches 301 to 308 are kept “ON” until the count value exceeds the register value; the corresponding switches 301 to 308 are turned “OFF” when the count value exceeds the register value.

The counter 330 is a 12-bit counter which increments the counter value, one by one from 1 to 4096, upon each rise of the LED clock signal LEDCLK. Accordingly, for example, when the register value of the LED register 321 is 4, as shown in FIG. 8, the switch control signal SW₁ outputted by the comparator 311 is at logic level “High” to keep the switch 301 on until the value outputted by the counter 330 exceeds 4, and once the value outputted by the counter 330 exceeds 4, the switch control signal SW₁ outputted by the comparator 311 is set to logic level “Low” to turn off the switch 301. Similar operations are performed, for example, when the register value of the LED register 322 is 8 as shown in FIG. 8.

Thereafter, when the count value of the counter 330 reaches 4096, the count value is reset to 1 at the next rise of the LED clock signal LEDCLK, and the one-by-one increment operation is further repeated. Accordingly, for example, when the register value of the LED register 321 is 4, an operation is repeated such that the corresponding white LED 22 is lit up for a time period equivalent to four of the 4096 clocks, and blacks out for a time period equivalent to the remaining 4092 clocks. Therefore, by appropriately adjusting the register value, it is possible to appropriately set the ratio of the light-up period of the white LED 22 to the blackout period, so that that the luminance thereof can be arbitrarily adjusted. Note that it is undesirable that repetition of the aforementioned operation is perceived by the eye as blinking light, and therefore it is preferable that intervals of that repetition be shorter than 1/60 seconds which cause the eye to perceive blinking light. Thus, it is preferable that the frequency of the LED clock signal LEDCLK be set considering the above.

<4. Effect>

As described above, according to the present embodiment, unique addresses are set using data sequentially provided to the backlight drive units via the serial signal line 131, allowing communications through the IIC bus 132 without presetting fixed addresses. In this manner, unique addresses can be automatically set for the backlight drive devices using a simplified configuration, and therefore it is possible to employ common backlight drive units. In addition, no address-setting operations are required at the time of replacement, and therefore it is possible to eliminate the trouble of repair and setting errors.

<5. Others>

In the above embodiment, the backlight 13 uses the white LEDs 22 as light sources, but in place of or together with them, combinations of red, green and blue LEDs may be used as light sources or cold cathode fluorescent lamps (CCFLs) may be used as light sources. Also, the liquid crystal panel 11 is made using a number of display elements 21 including liquid crystals, but in place of liquid crystals, shutter elements may be used, which are made of a well-known material having electro-optic properties which make it possible to control the transmittance of light from the backlight 13.

In the above embodiment, each of the fifteen backlight drive units 101 to 115 includes eight white LEDs 22, but the number of backlight drive units 101 to 115 and the number of white LEDs 22 are merely illustrative and can be arbitrarily determined by appropriately changing the content of the luminance data signal Ds. For example, by changing the address data included in the luminance data signal Ds to 5-bit data, it becomes possible to provide 32 backlight drive units, and in the case where eight backlight drive units are provided, the address data may be of 3 bits.

In the above embodiment, each of the backlight drive units 101 to 115 includes one temperature detector and one light-quantity detector and also includes two corresponding A/D converters corresponding to the detectors, but the detectors are not limited in number and type, and for example, either the temperature detector or the light-quantity detector may be included, either or both of them may be included in singularity or plurality, or a current detector, a voltage detector and/or the like may be included.

In the above embodiment, the serial signal line 131 and the IIC bus 132 are used respectively for providing addresses to the backlight drive units 101 to 115 and for performing communications based on the addresses, but in place of the serial signal line 131, another signal line may be used for connecting the backlight drive units 101 to 115 by a daisy-chain method or in place of the IIC bus 132, a signal line may be used to connect the backlight drive units 101 to 115 by a bus connection method which uses addresses, such as an SPI (Serial Peripheral Interface) or an SMBus (System Management Bus).

In the above embodiment, the luminance of each backlight is controlled independently of each other for the purpose of uniformly illuminating the display area, but it may be so configured in a display device employing a so-called area-active drive method. The area-active drive method refers to a method for driving a display panel while controlling the luminance of a backlight source corresponding to an area of a screen divided into a plurality of areas, based on an input image in that area. In a backlight-equipped image display device such as a liquid crystal display device, the luminance of a backlight is controlled based on an input image, thereby making it possible to minimize power consumption of the backlight and improve the quality of a display image. In an image display device in which the area-active drive is performed, the luminance (luminance of light emission) of LEDs corresponding to areas is appropriately obtained based on, for example, maximum and average luminance values of pixels in each area and provided to the backlight drive control portion as LED data. Also, display data (in the case of a liquid crystal display device, data for controlling the light transmittance of liquid crystals) is generated based on the LED data and the input image, and the display data is provided to a display panel drive circuit. In the case of a liquid crystal display device, the on-screen luminance of each pixel is a product of the luminance of light from a backlight and the light transmittance based on the display data. The display panel drive circuit may be driven based on the display data thus generated and the backlight may be driven based on the LED data, resulting in an image display based on the input image.

### INDUSTRIAL APPLICABILITY

The present invention is applicable to backlight devices including a plurality of backlight units and also to display devices equipped with such backlight devices, and for example, the invention is suitable for large-sized liquid crystal display devices equipped with a plurality of backlight units for illuminating a large display area and also suitable for backlight devices used in such liquid crystal display devices.

### DESCRIPTION OF THE REFERENCE CHARACTERS

10 . . . liquid crystal display device
11 . . . liquid crystal panel
12 . . . panel drive circuit
13 . . . backlight
14 . . . backlight drive control portion
15 . . . display control portion
21 . . . display element
22 . . . LED
101 to 115 . . . backlight drive unit
211, 212 . . . unit driver
212, 222 . . . temperature detector
213, 223 . . . light-quantity detector
214, 224 . . . first A/D converter
215, 225 . . . second A/D converter
301 to 308 . . . switch
311 to 318 . . . comparator
321 to 328 . . . LED register
340 . . . shift register
353 . . . address register
D₁ to D₁₅ . . . digital data
Ds . . . luminance data signal
DA . . . liquid crystal data
DB . . . LED data
DATA . . . data signal

1. A backlight drive device for controlling the luminance of a backlight including a plurality of light sources, the device comprising:
a plurality of drive units for controlling the luminance of one or more of the light sources, each drive unit including a detector for detecting one or more physical quantities including a light quantity and an ambient temperature of the one or more light sources, the one or more physical quantities being related to the luminance of the one or more light sources;
a control portion for receiving the physical quantity detected by the detector and generating and outputting a luminance data signal for controlling the luminance of a corresponding light source, based on the received physical quantity;
a first signal line for transmitting the luminance data signal and sequentially connecting the control portion to the drive units by a daisy-chain method; and
a second signal line for transmitting a signal indicating the physical quantity and connecting the drive units to the control portion by a bus method, wherein,
the control portion sequentially assigns unique addresses to the drive units via the first signal line, thereby allowing reception of the signal indicating the physical quantity from any of the drive units via the second signal line.

2. The backlight drive device according to claim 1, wherein,
each of the drive units includes a plurality of detectors for detecting different physical quantities,
the detectors add their respective different values to the address assigned to the drive unit including the detectors, thereby generating different addresses, and
the control portion receives the signal indicating the physical quantity from any of the detectors via the second signal line.

3. The backlight drive device according to claim 2, wherein,
each of the detectors includes an A/D converter for converting the detected physical quantity into digital data, and
the A/D converter has a previously fixed and set value to be added to the address, the value being common among the same type of A/D converters included in other drive units but being different from those of other A/D converters included in the same drive unit.

4. The backlight drive device according to claim 3, wherein,
each of the drive units includes a driver for controlling the luminance of the one or more light sources based on the luminance data signal provided via the first signal line, and
the driver receives the address provided via the first signal line and provides the address to the A/D converter.

5. The backlight drive device according to claim 3, wherein,
the detectors include first and second detectors for respectively detecting the light quantity of the one or more light sources and the ambient temperature, and
the A/D converters included in the first and second detectors have their respective input terminals capable of setting part or all of the addresses to be generated, one input terminal having either a ground potential or a power-supply potential consistently applied thereto so as to be at a different potential from the other input terminal.

6. The backlight drive device according to claim 1, wherein the control portion communicates with the drive units via the second signal line by an IIC bus method.

7. A backlight drive method for controlling the luminance of a backlight including a plurality of light sources, the method comprising:
a drive step by a plurality of drive units for controlling the luminance of one or more of the light sources, each drive unit including a detector for detecting one or more physical quantities including a light quantity and an ambient temperature of the one or more light sources, the one or more physical quantities being related to the luminance of the one or more light sources;
a control step by a control portion for receiving the physical quantity detected by the detector and generating and outputting a luminance data signal for controlling the luminance of a corresponding light source, based on the received physical quantity;
a first transmission step of transmitting the luminance data signal via a first signal line sequentially connecting the control portion to the drive units by a daisy-chain method; and
a second transmission step of transmitting a signal indicating the physical quantity via a second signal line connecting the drive units to the control portion by a bus method, wherein,
in the control step, unique addresses are sequentially assigned to the drive units via the first signal line, thereby allowing reception of the signal indicating the physical quantity from any of the drive units via the second signal line.
